(19) United States
(12) Patent Application Publication
(10) Pub. No.: US 2010/0096812 A1
(43) Pub. Date: Apr. 22, 2010

(54) METHOD FOR FORMING A SEAL BETWEEN AIR DUCTS AND/OR TERMINAL UNITS THEREOF AND A SEAL

(76) Inventors: Jari Hokkanen, Toijala (FI); Hannu Tiainen, Valkeakoski (FI)

Correspondence Address: BIRCH STEWART KOLASCH & BIRCH, PO BOX 747, FALLS CHURCH, VA, 22040-0747, US

(21) Appl. No.: 12/598,681

(22) PCT Filed: Apr. 8, 2008
(86) PCT No.: PCT/FI08/50169

§ 371 Date: Nov. 3, 2009

(30) Foreign Application Priority Data
May 14, 2007 (FI) 20075346

(51) Int. Cl. F16J 15/10; F16L 21/02

(52) U.S. Cl. 277/654; 156/244.13

(57) ABSTRACT

A method is disclosed for forming a seal between air ducts and/or terminal units thereof, the method comprising the step of extruding a caulking compound about the perimeter of the air duct to form a continuous seal (4). The invention is implemented by way of extruding the caulking compound by at least two layers so that a second layer (4′) is extruded radially over the first layer (4″).

The present invention concerns a method for forming a seal between air ducts and/or terminal units thereof, the method comprising the step of extruding a caulking compound about the perimeter of the air duct to form a continuous seal.

When joining air ducts or terminal units thereof so as to slide the elements partially overlappingly over one another, it is necessary to use a continuous seal encircling the entire perimeter of the inner duct element. This kind of rubber seals are available in factory-made shapes that can be mounted about the inner duct element and secured by way of, e.g., folding the front edge of the duct over the attachment base of the seal. The seal must have such a flexibility that it can bend down to fit into the narrow gap of the elements being joined. More specifically, the invention relates to ducts and/or terminal units of a round cross section, while also ducts of other shapes, e.g., oval or rectangular ducts are covered by the invention. However, the invention is next elucidated for use in conjunction with round ducts.

In the art is also known a method of making an annular seal by extruding a sealing bead of caulking compound about the duct. Caulking compounds, e.g., one traded under the product name of Sikaflex®, are suited for this application. After curing, the caulk adheres firmly to the duct surface thus needing no additional securing. The shape of the caulking spout is selected such that the seal directly assumes its desired cross section and an elastic form. The seal is extruded about the entire perimeter of the duct and, to secure its continuity, at the end along short distance in a parallel overlapping fashion. The overlapping length of the parallel beads invokes a risk of leak unless the overlapping beads cannot be brought to a full lateral contact with each other. Hence, the caulking process requires high precision and yet carries the risk of producing a leaky seal.

It is an object of the present invention to achieve a method offering easy fabrication of the seal that is circumferentially leakproof and substantially continuous. The method according to the invention is characterized in that the caulking compound is extruded by at least two layers so that the second layer is extruded radially over the first layer.

A preferred embodiment of the method according to the invention is characterized in that the caulking compound is extruded as a bead of a substantially round cross section.

Another preferred embodiment of the method according to the invention is characterized in that the caulking compound is extruded about the perimeter of a generally round duct and/or a terminal device thereof.

It is a further object of the invention to provide a seal fabricated according to the method. The seal is characterized in that the seal comprises at least two superimposed layers of caulking compound.

A preferred embodiment of the seal according to the invention is characterized in that both/all of the caulking compound layers have a substantially round cross section.

Another preferred embodiment of the seal according to the invention is characterized in that the seal is formed about the perimeter of a generally round duct and/or a terminal device thereof.

The benefits of the seal according to the invention include that its application disposes with the need for a separate fastening step, since during its curing the caulking compound adheres firmly to the surface thereunder. In the same fashion, also the superimposed layers of the seal adhere to each other as the caulking compound is cured. Moreover, the finished seal is entirely leakproof due to the lack of discontinuities.

The invention is next described in more detail with the help of a preferred exemplifying embodiment by making reference to the appended drawings in which

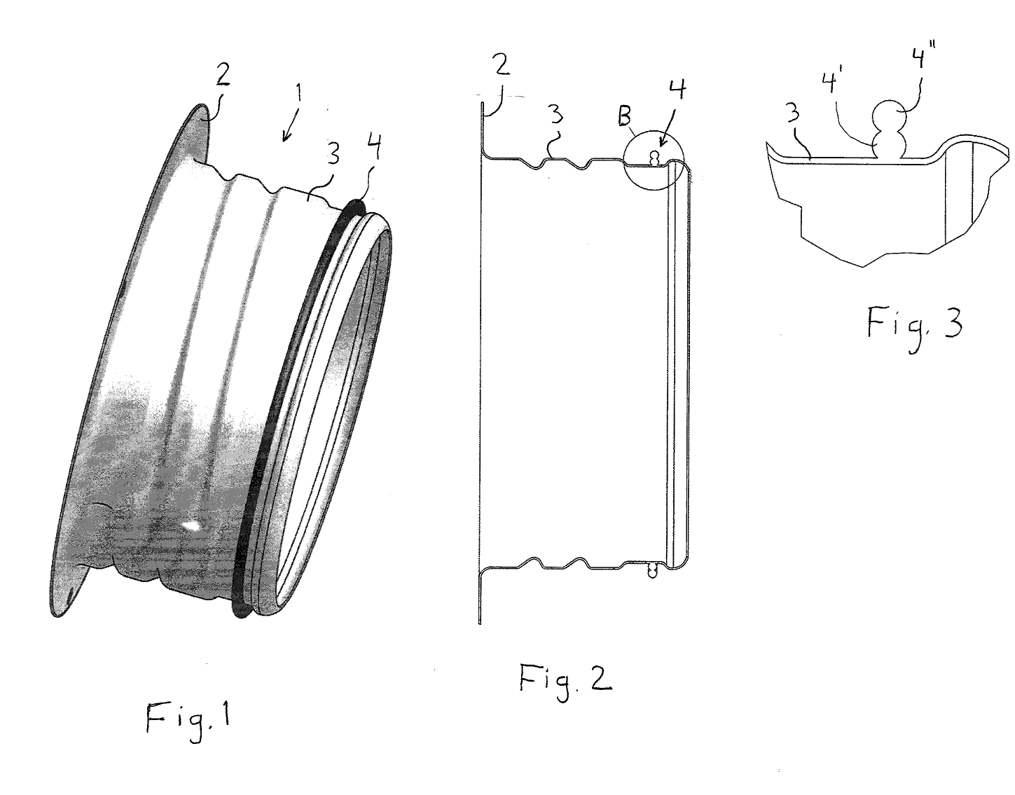

FIG. 1 shows in an air-conditioning system an axonometric view of a mounting frame of a terminal device equipped with a seal according to the invention;

FIG. 2 shows a cross-sectional view of the mounting frame; and

FIG. 3 shows an enlarged view of detail B of FIG. 2.

Accordingly, FIG. 1 illustrates a mounting frame 1, whose front edge 2 is fastened to the wall and whose tubular section 3 is attached to an air duct (not shown) by inserting the tubular section having a seal 4 thereon into the bore of the air duct. The joint is tight and the seal 4 adapted about the perimeter of the tubular section seals the joint in a conventional fashion by bending over into the gap between the elements being joined. As mentioned earlier, this description relates to air ducts of round cross section, but also other shapes of the air duct/terminal device cross section may be contemplated equally. Of them, particularly an oval air duct shape is fully compatible with the invention, as well as a rectangular air duct shape.

Again referring to FIG. 1, therein is shown a mounting frame employed in a conventional fashion to install a terminal device of a desired type, such as an inlet or outlet damper, for instance. However, a mounting frame 1 is only an exemplary case of the plural different ducts and devices compatible with this kind of a joint/seal arrangement.

FIGS. 2 and 3 illustrate the structure of seal 4 in greater detail. The seal comprises two superimposed seal layers 4′ and 4″, each having a substantially round cross section and adhering to each other. Although herein the embodiment is elucidated using a caulking compound bead of round cross section as the exemplary shape, the invention is not limited thereto. The bead may as well have an alternative cross section, e.g., an oval shape. The essential feature of the seal is that the bead of the second seal layer adheres to and stays firmly on the first layer thus eliminating discontinuities in the seal structure. Obviously, the bead shape must also be selected such that the seal forms a sufficiently leakproof joint.

The lowermost seal layer 4′ is adhered to the surface of the tubular section 3 of the mounting frame. The seal 4 is placed in the tubular section 3, e.g., in such a manner that the tubular section (mounting frame) is affixed to a mounting jig wherein the tubular section is rotated at a preset speed. An extrusion spout (not shown) adapted close to the tubular surface feeds the caulking compound (e.g., Sikaflex®) onto the surface. In this embodiment the cross section of the extrusion spout is circular thus delivering the compound as a round bead out of the spout. Owing to the rotational movement of the tubular section, the caulking compound will become applied about the entire perimeter thereof thus forming an annular seal. However, the extrusion of the caulking compound is not cut off after one complete rotation, but rather is continued to apply a second layer, whereby the outer layer will adhere to the underlying layer. The caulking compound is extruded by at least two layers (4′, 4″) as shown in the diagrams. Hence, the seal will become so high that it can bend into the gap of the duct joint. While not generally necessary, in principle even more than two layers may be applied.

To a person skilled in the art it is obvious that the invention is not limited by the above-described exemplary embodiments, but rather may be varied within the inventive spirit and scope of the appended claims. Accordingly, the type of caulking compound used may be different from that mentioned above. The essential feature of the invention is that the curing caulking compound makes it adhere to the tubular section and the outer compound layer similarly adheres to seal inner layer.

1. A method for forming a seal between air ducts and/or terminal units thereof, the method comprising the step of extruding a caulking compound about the perimeter of the air duct to form a continuous seal (4), characterized in that the caulking compound is extruded by at least two layers so that a second layer (4′) is extruded radially over the first layer (4″).

2. The method of claim 1, characterized in that the caulking compound is extruded as a bead of a substantially round cross section.

3. The method of claim 1, characterized in that the caulking compound is extruded about the perimeter of a generally round duct and/or a terminal device thereof.

4. A seal for sealing joints between air ducts and/or terminal units thereof, said seal (4) extending annularly about the entire perimeter of the duct and having an at least partially elastic structure and said seal being fabricated from a caulking compound by extrusion, characterized in that the seal comprises two superimposed seal layers (4′, 4″) adhering to each other.

5. The seal of claim 4, characterized in that both/all of the caulking compound layers have a substantially round cross section.

6. The seal of claim 4, characterized in that the seal is formed about the perimeter of a generally round duct and/or a terminal device thereof.

7. The method of claim 2, characterized in that the caulking compound is extruded about the perimeter of a generally round duct and/or a terminal device thereof.

8. The seal of claim 5, characterized in that the seal is formed about the perimeter of a generally round duct and/or a terminal device thereof.
